(19) United States
(12) Patent Application Publication
(10) Pub. No.: US 2016/0199692 A1
(43) Pub. Date: Jul. 14, 2016

(54) SIMULATOR MANAGING APPARATUS AND METHOD FOR ANALYZING POSTURE OF SIMULATOR USER

(71) Applicant: ELECTRONICS AND TELECOMMUNICATIONS RESEARCH INSTITUTE, Daejeon (KR)

(72) Inventors: Sang Seung KANG, Daejeon (KR); Kye Kyung KIM, Daegu (KR); Su Young CHI, Daejeon (KR); Jae Hong KIM, Daejeon (KR); Sung Woong SHIN, Daejeon (KR)

(21) Appl. No.: 14/993,896

(22) Filed: Jan. 12, 2016

(30) Foreign Application Priority Data
Jan. 14, 2015 (KR) 10-2015-0007010

(51) Int. Cl. A63B 24/00; G09B 19/00; G06N 5/04

(52) U.S. Cl. CPC A63B 24/0006; G06N 5/04; G09B 19/0038

(57) ABSTRACT

Provided is a simulator managing apparatus and method for analyzing the posture of a user. The simulator managing apparatus includes: an input configured to acquire environment information and image information with respect to a simulator and a user; a controller configured to recognize a position and a posture of the user by analyzing the information acquired by the input, and to generate control information that includes coaching information for posture correction of the user according to the recognized position and posture; and an output configured to provide the analysis and the control information generated by the controller.

### CROSS-REFERENCE TO RELATED APPLICATION(S)

This application claims priority from Korean Patent Application No. 10-2015-0007010, filed on Jan. 14, 2015, in the Korean Intellectual Property Office, the entire disclosure of which is incorporated herein by reference for all purposes.

### BACKGROUND

1. Field

The following description generally relates to a technology for sports simulators, and more particularly to a technology for analyzing postures of simulator users.

2. Description of the Related Art

Marine sports activities, such as yacht sailing, are increasingly receiving attention based on state support, and more and more people enjoy marine sports. However, geological and environmental limitations in marine sports make it difficult for ordinary people to participate in marine sports activities. In order to overcome such limitations, an indoor yacht simulator has been developed to enable people to easily experience marine sports activities.

A yacht is a boat propelled by wind acting on a sail, and yacht racing is a form of sport with non-powered yachts racing around a course marked by buoys. There are generally two types of sailing yacht: a cruiser and a dinghy. The cruiser yacht refers to sailing yachts or motor yachts that are built for long distance sailing and has a cabin, while the dinghy yacht is a type of small boat, and is propelled only by wind and is balanced by the weight of people on board. A yacht simulator is generally modelled on the dinghy yacht.

As in other sports simulators, research has been conducted on dynamics of the yacht simulator to realize natural motions, as well as on contents and auxiliary devices to improve a sense of reality. Along with all the contents and equipment for the yacht simulator, there is also a need for training of basic yacht techniques so that users may use the yacht simulator efficiently.

### SUMMARY

Provided is a simulator managing apparatus and method for analyzing the posture of a simulator user, in which the posture of a simulator user is analyzed to provide the user with effective education and training.

In one general aspect, there is provided a simulator managing apparatus, including: an input configured to acquire environment information and image information with respect to a simulator and a user; a controller configured to recognize a position and a posture of the user by analyzing the information acquired by the input, and to generate control information that includes coaching information for posture correction of the user according to the recognized position and posture; and an output configured to provide the analysis and the control information generated by the controller.

The coaching information may include analysis information obtained by comparing reference data predetermined for a current status with the recognized position and posture of a user. The coaching information may include recommendation information that includes a position and a posture recommended to the user. The environment information may include at least one of: wind-related information, information associated with a tidal current and waves; boat-related information, such as a boat velocity, a boat trim of a bow and a stern, and a boat trim of a port and a starboard, main sheet information, rudder information, center board information, dagger board information, boom state information.

The controller may include: an analyzer configured to extract posture characteristics of the user by analyzing the acquired image information, and to extract environment characteristics by analyzing the acquired environment information; a recognizer configured to recognize the position and posture of the user based on the extracted posture characteristics of the user, and to recognize a current status of the simulator based on the extracted environment characteristics; and a simulator controller configured to generate control information to reflect a result of the recognition, obtained by the recognizer, in the simulator.

The recognizer may recognize the position of the user by dividing a yacht into a plurality of areas based on a center of the simulator installation, and calculating a position function in each divided area. The recognizer may recognize the position of the user by using the environment information including a wind velocity, the boat velocity, the port and starboard size of the hull, the boat trim of the bow and the stern. The recognizer may recognize a lean angle when a user hikes out by using center points of a head, shoulders, a waist, or a bottom of the user, and the trim angle of the port and the starboard.

The recognizer may generate status information to recognize the posture of the user by using the extracted environment characteristics, and recognizes the position and posture of the user by using the generated status information.

The simulator controller may compare the position and posture of the user, which are recognized by the recognizer, with a reference position and posture predetermined by normalizing positions and postures with respect to body information, and generates analysis information based on the comparison.

The simulator controller may generate recommendation information, which includes the recommended position and the recommended lean angle when the user hikes out, by using the reference posture information predetermined according to the status recognized by the recognizer.

The output may include: a content representator configured to output the analysis and the control information in contents; and a sensory effect representator configured to provide sensory feedback to the user.

In another general aspect, there is provided a simulator managing method, including: acquiring environment information and image information with respect to the simulator and a user; recognizing a position and a posture of the user by analyzing the information acquired by the input, and generating control information that includes coaching information for posture correction of the user according to the recognized position and posture; and providing the analysis and the generated control information.

The coaching information may include analysis information obtained by comparing reference data predetermined for a current status with the recognized position and posture of the user, and recommendation information that includes a position and a posture recommended to the user.

The generating of the control information may include generating status information to recognize the posture of the user by using environment characteristics extracted from the acquired environment information, and recognizing the position and posture of the user by using the generated status information.

The generating of the control information may include comparing the position and posture of the user, which are recognized by the recognizer, with a reference position and posture predetermined by normalizing positions and postures with respect to body information, and generating analysis information based on the comparison.

The generating of the control information may include generating recommendation information, which includes the recommended position and the recommended lean angle when the user hikes out, by using the reference posture information predetermined according to the status recognized by the recognizer.

### BRIEF DESCRIPTION OF THE DRAWINGS

FIG. 1 is a diagram illustrating a simulation system according to an exemplary embodiment.

FIG. 2 is a diagram illustrating a simulator managing apparatus illustrated in FIG. 1 according to an exemplary embodiment.

FIG. 3 is a diagram illustrating a controller illustrated in FIG. 2 according to an exemplary embodiment.

FIG. 4 is a flowchart illustrating a process of analyzing and recognizing the posture of a yacht simulator user according to an exemplary embodiment.

FIG. 5 is a diagram illustrating a yacht simulator to explain an example of recognizing the position of a yacht simulator user according to an exemplary embodiment.

FIG. 6 is a diagram illustrating a recognition result of a user position according to an exemplary embodiment.

FIG. 7 is a diagram illustrating a recognition result of leaning when a yacht simulator user hikes out according to an exemplary embodiment.

FIG. 8 is a detailed diagram illustrating an output illustrated in FIG. 2 according to an exemplary embodiment.

FIG. 9 is a flowchart illustrating a method of analyzing the posture of a yacht simulator user according to an exemplary embodiment.

FIG. 10 is a diagram illustrating a computer system implementing the present invention.

Throughout the drawings and the detailed description, unless otherwise described, the s same drawing reference numerals will be understood to refer to the same elements, features, and structures. The relative size and depiction of these elements may be exaggerated for clarity, illustration, and convenience.

### DETAILED DESCRIPTION

Hereinafter, the present disclosure will be described in detail with reference to the accompanying drawings. The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. Terms used throughout this specification are defined in consideration of functions according to exemplary embodiments, and can be varied according to a purpose of a user or manager, or precedent and so on. Therefore, definitions of the terms should be made on the basis of the overall context.

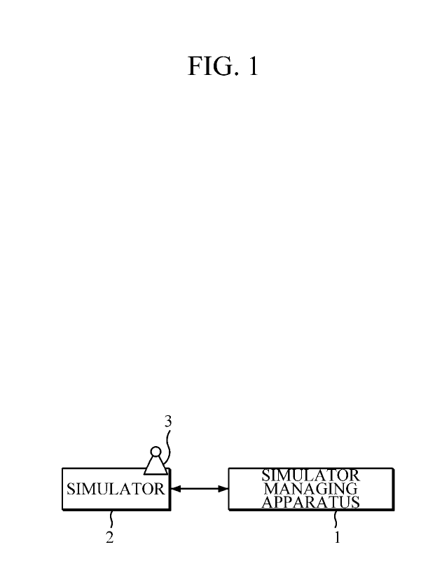

FIG. 1 is a diagram illustrating a simulation system according to an exemplary embodiment.

Referring to FIG. 1, the simulation system includes a simulator 2 and a simulator managing apparatus 1.

Although the simulator 2 and the simulator managing apparatus 1 are separately illustrated in FIG. 1, which are separated according to their functions, the simulator 2 and the simulator managing apparatus 1 may be integrated in hardware. Alternatively, although the simulator 2 and the simulator managing apparatus 1 are separated, some elements of the simulator 2 may be located in the simulator managing apparatus 1, or conversely, some elements of the simulator managing apparatus 1 may be located in the simulator 2. Constituent elements may interwork with each other by using a predetermined protocol.

The simulator 2 is a device to enable a user 3 to experience real activities by doing indoor virtual activities. For example, if a user who wishes to experience or train for yacht sailing boards or operates a yacht simulator, the yacht simulator provides a virtual environment in which the user feels as if they were sailing on the real sea, lake, river, or the like. The simulator 2 according to an exemplary embodiment includes a yacht simulator, a user interface for providing contents, a sensory device for delivering feedback to a user, and the like. The yacht simulator includes a yacht body and other hardware devices necessary for physically controlling the yacht.

The simulator managing apparatus 1 is a device for managing and controlling the simulator 2. In one exemplary embodiment, the simulator managing apparatus 1 analyzes the position and posture of the user 3 when the user 3 uses the simulator 2, provides a result of the analysis, and controls the simulator 2 and the user 3 according to the analysis result. For example, the simulator managing apparatus 1 provides teaching information to the user 3 through the simulator 2. The teaching information is information to analyze and correct a user's postures, and may include information on a user's current position and posture, recommendation information according to a current status, and comparative information of reference information, such as expert data, with user data.

In one exemplary embodiment, the simulator managing apparatus 1 analyzes a user's postures, and evaluates the postures based on expert data to guide a user. Further, the simulator managing apparatus 1 checks a status of a currently operating yacht simulator, and provides appropriate feedback according to the position and posture of a user. In this manner, an effective training may be provided to a user as the yacht simulator may be operated in an indoor environment by replacing a real sailing yacht having geographical and environmental limitations.

The simulator managing apparatus 1 may be applied to simulations of sports, such as yacht, golf, baseball, and the like, which requires posture correction. For convenience of explanation, a yacht simulation will be described as an example in the present disclosure. However, the present disclosure is not limited thereto, and may be used in all the applications that require correction of a user's postures. For example, the present disclosure may be used in other applications, ranging from simulations for a job training to simulations for an aircraft flight training, as well as sports activities.

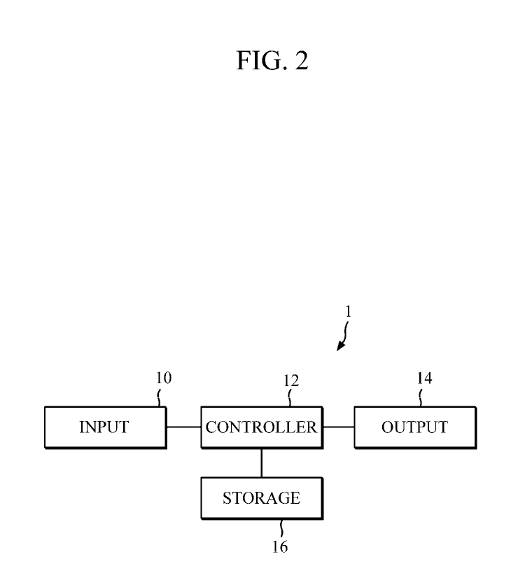

FIG. 2 is a diagram illustrating a simulator managing apparatus illustrated in FIG. 1 according to an exemplary embodiment.

Referring to FIG. 2, the simulator managing apparatus 1 includes an input 10, a controller 12, and an output 14.

The input 10 acquires environment information and image information with respect to a simulator and a user. The environment information refers to information on environmental factors or surroundings that may affect a current state of simulation. For example, the environment information may include: wind-related information, such as wind directions, wind pressures, wind velocities, and the like; information associated with the tidal current and waves; information associated with the hull of a sailboat, such as the velocity of the hull, the boat trim of the bow and the stern, the boat trim of the port and the starboard; and the like. Further, the environment information may include: information on a main sheet which is a rope to trim a main sail; information on a rudder which serves as a helm for steering a boat; information on a center board or a dagger board that is positioned on the bottom of the center of a ship to move upwards or downwards and is used to provide lift to counter the lateral force from the sails; state information of a boom that supports the foot of a sail and is attached to a mast, which is a pole that rises vertically from a ship and supports a main sail. The environment information may be acquired by using various sensors of a simulator that includes a yacht simulator, and may also be acquired from contents. Alternatively, the environment information may be acquired from a yacht controlling device, or may be acquired directly from a user. The image information may be acquired by using image acquiring devices such as cameras. The acquired images may be used to recognize the position, leaning, and posture of a user.

The controller 12 analyzes the environment information and image information acquired by the input 10 to recognize the position and posture of a user, and generates control information to control a simulator based on the recognition. The control information includes coaching information for posture correction of a user.

In one exemplary embodiment, the coaching information includes analysis information obtained by comparing reference data predetermined for a current status with the recognized position and posture of a user. The predetermined reference data may be data of positions and postures of professionals, athletes, or instructions in a related field. The comparative analysis information may be represented by values of accuracy or similarity. Alternatively, positions and postures of a user may be compared with those of professionals, and comparison results may be shown as contents of a simulator.

The coaching information includes recommendation information that includes positions and postures recommended to a user. The posture information of a user includes information on leaning of a user. The information on leaning of a user may be associated with a hike-out when a user leans their body outside the boat to act as ballast to balance the boat.

The output 14 represents output information in contents, and provides feedback to a user by using a sensory device. The output 14 outputs a result of analysis and teaching information in contents. The output 14 provides sensory feedback to a user. The sensory representations for feedback may include applying motions of heeling or moving of a yacht, changing a view seen by a user by using visual representations in contents, or applying acoustic effects by using a sound or voice output device, or other sensory effects, such as wind, or fragrance, water, or water vapor.

A storage 16 stores information on a simulator user, history information of a user, teaching information, and the like in a database. The database may be included in the simulator managing apparatus 1, and may be managed separately and may be connected through a communication network.

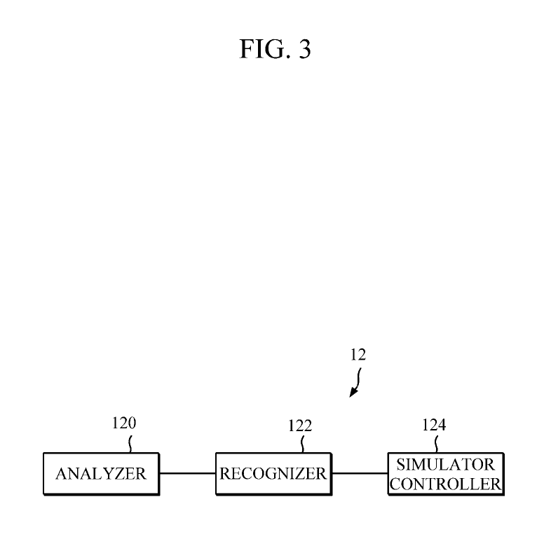

FIG. 3 is a diagram illustrating a controller illustrated in FIG. 2 according to an is exemplary embodiment.

Referring to FIG. 3, the controller 12 includes an analyzer 120, a recognizer 122, and a simulator controller 124.

The analyzer 120 analyzes image information to extract posture images of a user, and extracts posture characteristics of a user from the extracted posture images. Then, the analyzer 120 analyzes environment information to extract environment characteristics.

The recognizer 122 recognizes the position and posture of a user based on a user's posture characteristics extracted by the analyzer 120, and recognizes a current status of a simulator based on the extracted environment characteristics.

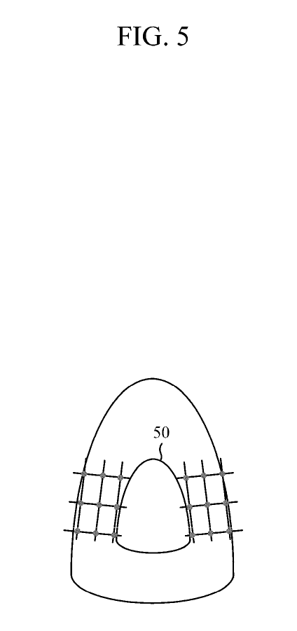

In one exemplary embodiment, the recognizer 122 may recognize a user's position by dividing the yacht into a plurality of areas based on the center of a yacht, and calculating a position function in each divided area. In this case, the recognizer 122 recognizes a user's position by using environment information including the velocity of wind, the velocity of the hull, the port and starboard size of a hull, the boat trim of the bow and the stern, and the like. An example of calculating the position function will be described in detail later with reference to FIG. 5.

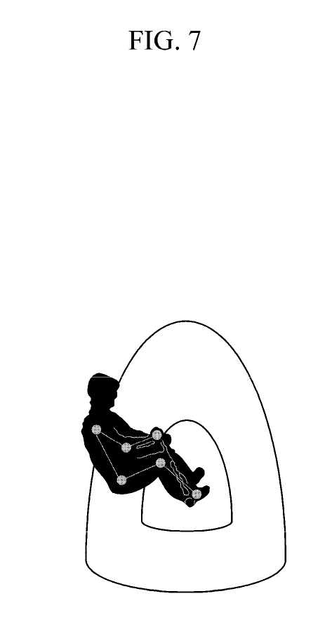

The recognizer 122 recognizes a lean angle when a user hikes out by using center points of a user's shoulders, waist or bottom, and a trim angle of the port and starboard of the hull. An example of recognizing hike out will be described in detail later with reference to FIG. 7.

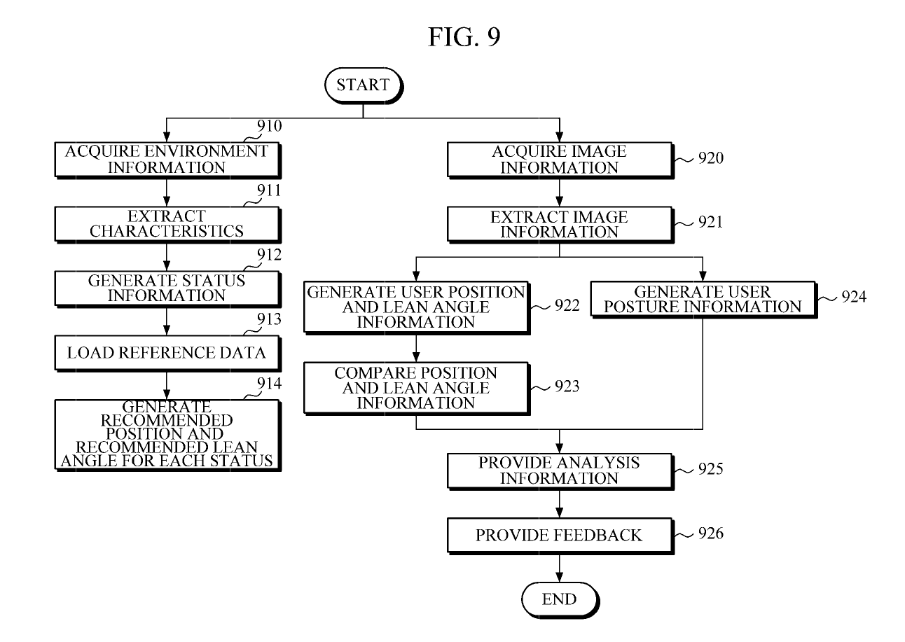

In one exemplary embodiment, the recognizer 122 generates status information for recognizing a user's posture by using the environmental characteristics extracted by the analyzer 120, and recognizes a user's position and posture by using the generated status information. An example of recognizing a user's position and posture by using the status information will be described in detail later with reference to FIG. 9.

The simulator controller 124 generates control information to reflect recognition results of the recognizer 122 to a simulator. In one exemplary embodiment, the simulator controller 124 generates comparative analysis information by comparing a user's position and posture recognized by the recognizer 122 with a reference position and posture predetermined by normalizing positions and postures with respect to body information. The simulator controller 124 generates recommendation information that includes a recommended position according to a situation recognized by the recognizer 122 and a recommended lean angle during the hike-out. An example of generating comparative analysis information and recommendation information will be described in detail later with reference to FIG. 9.

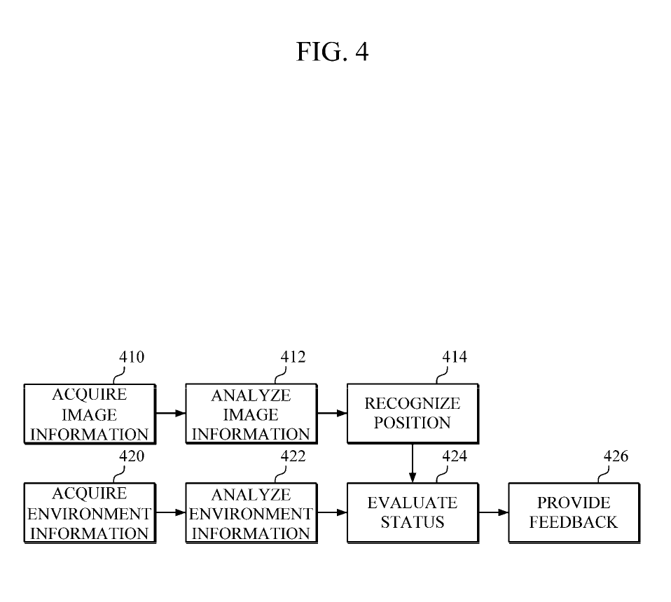

FIG. 4 is a flowchart illustrating a process of analyzing and recognizing the posture of a yacht simulator user according to an exemplary embodiment.

Referring to FIG. 4, the simulator managing apparatus acquires images of a simulator and a user, and analyzes the acquired images in 412. In this case, the simulator managing apparatus selects a region of interest in which a user's posture is to be identified, and extracts images of a user's posture in the selected region of interest. Further, the simulator managing apparatus may extract a user's posture characteristics from the extracted images of a user's posture. Subsequently, the simulator managing apparatus recognizes a user's posture, including a user's position and lean angle, based on a user's posture characteristics in 414.

The simulator managing apparatus acquires environment information from a simulator in 420. The environment information refers to information on environmental factors or surroundings that may affect yacht sailing, and examples of the environment information may include: a boat trim and velocity shown in contents, or wind directions or velocities shown in contents or a wind power installation, and the like. The environment information may further include information on the trim of a yacht simulator and state information regarding a yacht adjusting device. The simulator managing apparatus analyzes the acquired environment information in 422, and may extract environment characteristics from the environment information. Subsequently, the simulator managing apparatus evaluates a current status of a simulator in 424 by using the analyzed environment information and position information recognized in 414. For example, a boat balance and a boat trim may be evaluated. Then, the simulator managing apparatus provides feedback in 426 so that the evaluated current status may be reflected in a simulator. For example, feedback is provided to a yacht simulator, contents, a sensory device, and the like of a simulator.

FIG. 5 is a diagram illustrating a yacht simulator to explain an example of recognizing the position of a yacht simulator user according to an exemplary embodiment.

Referring to FIG. 5, a left area and a right area are separated based on the center of a cockpit 50 located in the middle of a yacht, to recognize a user's position. Further, each area is then divided into three areas from the bow to the stern and into three areas from the bow to the starboard, to recognize positions based on the center point of each area. However, the embodiment is merely illustrative to assist in the understanding of the present disclosure, such that the present disclosure is not limited thereto.

The left side and the right side, which correspond to the port and the starboard of a boat, may be determined according to directions of wind. It may be assumed that a user's position in each area is affected by the wind velocity, the boat velocity, a boat trim of the port and starboard, and a boat trim of the bow and stern. In this case, assuming that a user's position is Pij (1≦i, j≦3, i and j each being an integer), the wind velocity is wᵥ, the boat velocity is hᵥ, a boat trim of the port and the starboard is T_{side}, and a boat trim of the bow and the stern is T_{bow}, the position function of each i and j may be represented by the following Equation 1.

f(Pᵢ)=δₙ·(wᵥ+ωᵢT_{side})

f(Pⱼ)=δₙ·(hᵥ+ωⱼT_{bow}) [Equation 1]

Herein, δₙ is a normalization factor for body information including the height and weight of a user, and wᵢ and wⱼ are weight factors for directions i and j.

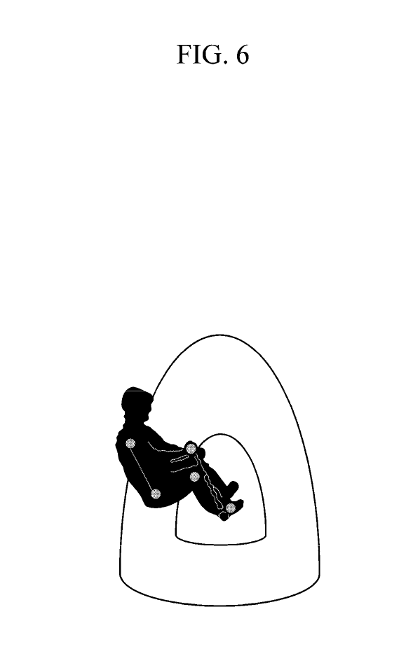

FIG. 6 is a diagram illustrating a recognition result of a user position according to an exemplary embodiment, and FIG. 7 is a diagram illustrating a recognition result of leaning when a yacht simulator user hikes out, according to an exemplary embodiment.

Referring to FIGS. 6 and 7, the recognized position of a user may be indicated by using a silhouette, a physique, and characteristics of a user. Assuming that information on leaning of a user when a user hikes out is based on center points of a user's head, shoulders, waist or bottom, and the center points are c₁(x₁, y₁) and c₂(x₂, y₂) respectively, the lean angle θₕᵢₖₑ (0°≦δₕᵢₖₑ≦90°) may be represented by the following Equation 2.

$${θ}_{hike} = {tan}^{- 1} \vert \frac{{y}_{1} - {y}_{2}}{{x}_{1} - {x}_{2}} \vert - {ω}_{h} {θ}_{hull} \qquad [ Equation 2 ]$$

Herein, δₕᵤₗₗ is a trim angle of the port and the starboard, and wₕ is a weight factor. In the case where the trim angle of the port and the starboard is not considered, wₕ is 0.

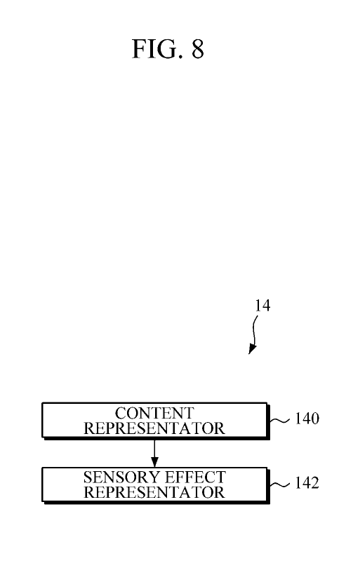

FIG. 8 is a detailed diagram illustrating an output illustrated in FIG. 2 according to an exemplary embodiment.

Referring to FIG. 8, the output 14 includes a content representator 140 and sensory effect representator 142.

The content representator 140 represents a sailing environment, such as the sea, lake, or river, by using visual and acoustic elements, and provides sailing information to a yacht simulator user during the sailing. The sailing information includes user information, environment information, logging information, correction information, and the like.

The sensory effect representator 142 is a device used to produce sensory effects by using wind, fragrance, water, or water vapor, other than the visual or acoustic elements of contents, so as to further improve a sense of reality.

FIG. 9 is a flowchart illustrating a method of analyzing the posture of a yacht simulator user according to an exemplary embodiment.

Referring to FIG. 9, once a user boards a yacht simulator and is ready to or starts to operate the yacht simulator, a simulator managing apparatus acquires environment information from a simulator in 910 that includes a yacht installation, contents, a sensory device, and the like. The environment information may include the velocity and directions of wind, the velocity of a boat, a boat trim, state information, and the like. The simulator extracts environment characteristics from the acquired environment information in 911. Then, the simulator managing apparatus generates status information to analyze a user's posture by using the extracted environment characteristics in 912. The simulator managing apparatus analyzes a user's position and posture based on the generated environment information, and loads reference data, e.g., expert data, for providing coaching information in 913. Information on a recommended position and a lean angle for each status, which includes a recommended position appropriate for a current status and a recommended lean angle when a user hikes out, is generated in 914.

Further, images are acquired by using an image sensing device and the like in 920, images of a user's posture in a region of interest are extracted from the acquired images, a user is separated from a background, and image characteristics of a user's posture are extracted in 921. By using the extracted image characteristics, a current position of a yacht simulator user and a lean angle are generated in 922. A user's current position and lean angle are compared with a recommended position and lean angle for each status, and the comparison results are analyzed in 923. In this case, data may be represented by values of accuracy or similarity. Further, user posture information, such as a user's silhouette or physique, is generated by using the extracted image characteristics in 924.

Subsequently, comparison results of a user's position and lean angle, as well as a user's posture, are provided to a user through a simulator. For example, analysis information is reflected in contents and the reflected information is output in 925. Feedback information is provided to a yacht simulator, contents, and a sensory device in 926 so that a status of a yacht that includes a boat balance and a boat trim may be reflected. The above-described user position information, a recommended position and lean angle for each status, and comparison results with reference data are included in teaching information.

When a user uses a simulator, e.g., a yacht simulator, the posture and position of the user is analyzed by acquiring environment information and image information, so that the simulator may be used effectively to train the user by coaching the user posture. Further, a sense of reality and immersion may be enhanced by providing sensory feedback, thereby enabling users to easily learn the yacht techniques with more fun.

Moreover, in a training space visualized based on real-time simulation, the simulator may be used widely in various applications by using scenarios in user's activities. Further, the simulator may be used in a space of full immersion virtual reality by using simulation scenarios and by analyzing a user's postures based on real-time simulation, so that users may have education and training that seem like a real situation, thereby improving competence of users and enabling them to have fun.

As described above, the effective method of analyzing the posture of a simulator user may contribute to the development of a related technical market.

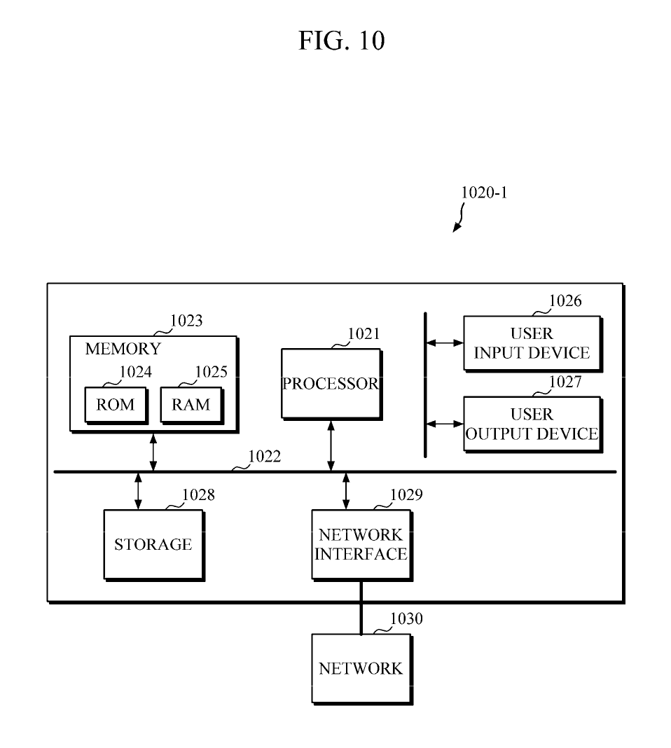

An embodiment of the present invention may be implemented in a computer system, e.g., as a computer readable medium. As shown in in FIG. 10, a computer system 1020-1 may include one or more of a processor 1021, a memory 1023, a user input device 1026, a user output device 1027, and a storage 1028, each of which communicates through a bus 1022. The computer system 1020-1 may also include a network interface 1029 that is coupled to a network 1030. The processor 1021 may be a central processing unit (CPU) or a semiconductor device that executes processing instructions stored in the memory 1023 and/or the storage 1028. The memory 1023 and the storage 1028 may include various forms of volatile or non-volatile storage media. For example, the memory may include a read-only memory (ROM) 1024 and a random access memory (RAM) 1025.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other is implementations are within the scope of the following claims. Further, the above-described examples are for illustrative explanation of the present invention, and thus, the present invention is not limited thereto.

What is claimed is:

1. A simulator managing apparatus, comprising:
an input configured to acquire environment information and image information with respect to a simulator and a user;
a controller configured to recognize a position and a posture of the user by analyzing the information acquired by the input, and to generate control information that includes coaching information for posture correction of the user according to the recognized position and posture; and
an output configured to provide the analysis and the control information generated by the controller.

2. The simulator managing apparatus of claim 1, wherein the simulator is a yacht simulator using a yacht installation.

3. The simulator managing apparatus of claim 1, wherein the coaching information includes analysis information obtained by comparing reference data predetermined for a current status with the recognized position and posture of the user.

4. The simulator managing apparatus of claim 1, wherein the coaching information includes recommendation information that includes a position and a posture recommended to the user.

5. The simulator managing apparatus of claim 1, wherein the environment information includes at least one of: wind-related information, information associated with a tidal current and waves; boat-related information, such as a boat velocity, a boat trim of a bow and a stern, and a boat trim of a port and a starboard, main sheet information, rudder information, center board information, dagger board information, boom state information.

6. The simulator managing apparatus of claim 1, wherein the controller comprises:
an analyzer configured to extract posture characteristics of the user by analyzing the acquired image information, and to extract environment characteristics by analyzing the acquired environment information;
a recognizer configured to recognize the position and posture of the user based on the extracted posture characteristics of the user, and to recognize a current status of the simulator based on the extracted environment characteristics; and
a simulator controller configured to generate control information to reflect a result of the recognition, obtained by the recognizer, in the simulator.

7. The simulator managing apparatus of claim 6, wherein the recognizer recognizes the position of the user by dividing a yacht into a plurality of areas based on a center of the simulator installation, and calculating a position function in each divided area.

8. The simulator managing apparatus of claim 6, wherein the recognizer recognizes the position of the user by using the environment information including a wind velocity, the boat velocity, the port and starboard size of the hull, the boat trim of the bow and the stern.

9. The simulator managing apparatus of claim 6, wherein the recognizer recognizes a lean angle when a user hikes out by using center points of a head, shoulders, a waist, or a bottom of the user, and the trim angle of the port and the starboard.

10. The simulator managing apparatus of claim 6, wherein the recognizer generates status information to recognize the posture of the user by using the extracted environment characteristics, and recognizes the position and posture of the user by using the generated status information.

11. The simulator managing apparatus of claim 6, wherein the simulator controller compares the position and posture of the user, which are recognized by the recognizer, with a reference position and posture predetermined by normalizing positions and postures with respect to body information, and generates analysis information based on the comparison.

12. The simulator managing apparatus of claim 6, wherein the simulator controller generates recommendation information, which includes the recommended position and the recommended lean angle when the user hikes out, by using the reference posture information predetermined according to the status recognized by the recognizer.

13. The simulator managing apparatus of claim 1, wherein the output comprises:
a content representator configured to output the analysis and the control information in contents; and
a sensory effect representator configured to provide sensory feedback to the user.

14. A simulator managing method, comprising:
acquiring environment information and image information with respect to the simulator and a user;
recognizing a position and a posture of the user by analyzing the information acquired by the input, and generating control information that includes coaching information for posture correction of the user according to the recognized position and posture; and
providing the analysis and the generated control information.

15. The method of claim 14, wherein the coaching information includes analysis information obtained by comparing reference data predetermined for a current status with the recognized position and posture of the user, and recommendation information that includes a position and a posture recommended to the user.

16. The method of claim 14, wherein the generating of the control information comprises generating status information to recognize the posture of the user by using environment characteristics extracted from the acquired environment information, and recognizing the position and posture of the user by using the generated status information.

17. The method of claim 14, wherein the generating of the control information comprises comparing the position and posture of the user, which are recognized by the recognizer, with a reference position and posture predetermined by normalizing positions and postures with respect to body information, and generating analysis information based on the comparison.

18. The method of claim 14, wherein the generating of the control information comprises generating recommendation information, which includes the recommended position and the recommended lean angle when the user hikes out, by using the reference posture information predetermined according to the status recognized by the recognizer.
